(19) United States
(12) Patent Application Publication
(10) Pub. No.: US 2023/0174291 A1
(43) Pub. Date: Jun. 8, 2023

(54) INSULATING HOLDER AND METHOD FOR TRANSPORTING BEVERAGES

(71) Applicants: Eugene JENSEN, Vanderbijlpark (ZA); Johannes Samuel PEEK, Vanderbijlpark (ZA)

(72) Inventors: Eugene JENSEN, Vanderbijlpark (ZA); Johannes Samuel PEEK, Vanderbijlpark (ZA)

(21) Appl. No.: 17/924,196

(22) PCT Filed: May 10, 2021
(86) PCT No.: PCT/ZA2021/050031

§ 371 Date: Nov. 9, 2022

(30) Foreign Application Priority Data
May 11, 2020 (ZA) 2020/02602

(51) Int. Cl. B65D 81/38; B65D 25/10; B65D 81/133; B65D 43/02

(52) U.S. Cl. CPC B65D 81/3816; B65D 25/108; B65D 81/133; B65D 43/0235; B65D 2581/05; B65D 2543/0087

(57) ABSTRACT

The invention provides an insulating transport container (10) for transportation of beverages in ready to drink on demand beverage containers over short distances where temperature control is needed inside the beverage container when transporting the hot or cold beverages and which includes an insulating holder for cups (34) positioned or placed therein, which insulating holder (25) reduces temperature changes and inhibits spillage during transportation of cups (34) containing a beverage, wherein the holder includes one or more self supporting resiliently deformable insulating material portions with at least one portion (24) having a plurality of cup receiving cavities (26), which holder is sized and dimensioned to be placed inside the transport container for the transportation of beverages. The invention further provides an insert cover (50) for a beverage cup, said insert cover being a sheet of food grade material which is larger or equivalent in diameter to the top of the cup on which it is to be used and, in use, is placed or inserted to form a cover insert between the top of the cup and a sealing lid, provided that the cover is not sealed or otherwise secured to the cup prior to placing of the lid onto the cup and is only inserted after a beverage has been dispensed into the cup. The invention extends to a method of transporting a beverage.

### FIELD OF THE INVENTION

The invention relates to the transportation of beverages in ready to drink size containers, such as cups.

### BACKGROUND TO THE INVENTION

The inventors are aware of a beverage container supporting cushion which is known from the prior art e.g. US 2016/0278556. This cushion also comprises of cup receiving cavities to support beverage mugs on “stationary” uneven surfaces such as couches, beds, ground surfaces etc. Cup supporting inserts are positioned within lateral sleeves being pressed against the container base. All mugs placed inside the cavities would rest on the inserts against the container base.

The inventor has identified a need for an apparatus and a method for road transporting beverages in ready to drink container sizes, such as cups, over short distances where temperature control is needed inside the container when transporting the hot or cold beverages.

### SUMMARY OF THE INVENTION

According to a first aspect of the invention, there is a provided an insulating transport container for transportation of beverages in ready to drink on demand containers, such as cups, over short distances where temperature control is needed inside the container when transporting the hot or cold beverages and wherein an insulating holder for cups is positioned or placed inside the container, which insulating holder reduces temperature changes and inhibits spillage during transportation of cups containing a beverage, wherein the holder includes one or more self supporting resiliently deformable insulating material portions with at least one portion having a plurality of cup receiving cavities, which holder is sized and dimensioned to be placed inside a container for the transportation of beverages.

The resiliently deformable insulating material may be foam or sponge.

The resiliently deformable insulating material may be a natural material such as sponge, foam, including Latex, memory foam, or high density poly-urethane foam, wood composite, cork, or the like.

The one or more self supporting resiliently deformable insulating material portions may be in the form of a bottom layer, a middle layer and a top layer.

The layers may be individual layers or two or more may be secured together.

The plurality of cup-receiving cavities may be spaced apart from each other and extend through the middle layer thereby to permit the cups retained therein to be maintained to be interference free of each other.

The diameter of the cavities may be smaller than the largest diameter of the smallest cup of the cups to be received therein thereby to provide a snug-fit for each cup.

The insulating container may have a base portion, sidewalls, and a displaceable lid with the height between the base portion and the inner surface of the lid being greater than the height of any cup to be transported therein, with the top-end of each cup, once placed in position, protruding from the insulating holder's middle layer irrespective the various heights of each cup.

The top end of each cup may protrude to a similar height above the top of the middle layer of the insulating holder.

A more rigid structure of the foam or sponge of the insulating holder assists with the snug-fit of the various sizes of cups and improves stability thereby inhibiting spillage and insulating the cups and their contents during transportation either by motorcar, motorcycle or scooter.

The insulating container that houses the insulating holder may have the top sponge layer adjacent an inner surface of the lid thereof so that in use it closes onto the lids off each of the cups, leaving an air gap between the top and middle sponge layers where the lids and the top quarter of the cups will be located, while pressing down on the lid to deform over the lid thereby to stabilize the lid on the cup.

The insulating container may include four polystyrene side panel inserts at or on the sidewalls to enhance insulation inside the container when closed.

The insulating container may have the bottom sponge layer placed at or on the base portion of the container to assist with absorbing any minor spillage or condensation that may occur during transportation.

The insulating holder may be made of flexible canvas material.

An additional polystyrene panel may be inserted in a central portion of the container to divide the container into two smaller “pockets” or halves that improves insulation and can be used for hot and cold beverages simultaneously in the same container.

The top sponge may have steam release holes if steam needs to be vented or released from a small hole in each of the lids covering the cups.

The sponge or foam making-up the holder comprises of typical mattress foam material, such as polyurethane foam, memory foam, and latex.

According to a second aspect of the invention, there is provided an insert cover for a beverage cup, said insert cover being a sheet of food grade material which is larger or equivalent in diameter to the top of the cup on which it is to be used and, in use, is placed or inserted to form a cover insert between the top of the cup and a sealing lid, provided that the cover is not sealed or otherwise secured to the cup prior to placing of the lid onto the cup and is only inserted after a beverage has been dispensed into the cup.

The insert cover may be a wax paper insert, natural fiber/cellulose based insert, a composite sheet or polymer film based insert, a silicon based insert, or metallized film.

According to a further aspect of the invention, there is provided a method of inhibiting spillage of a beverage from a disposable or re-usable cup when being transported, said method including:
dispensing a beverage into the cup;
placing a cover insert for the beverage between a lip at the top of a cup and a clip on lid for the cup, which cover is made of food grade material, and which is larger or equivalent in diameter to the top of the cup on which it is to be used,
   in which method the cover is not sealed or otherwise secured to the cup prior to placing of the lid onto the cup and is only placed in position after the beverage has been dispensed into the cup and is held in place by gravity or the clip on lid.

The cup in the method is usually a paper, paperboard, plastics, or other cup typically used for on-demand beverage supply.

The cover may be a wax paper insert, natural fiber/cellulose based insert, a composite sheet or polymer film based insert, a silicon based insert, or metallized film.

The invention extends to a method of transporting beverages in ready to drink form, such as coffee, tea or cold drinks in cups, said method including snugly holding said cups in a resiliently deformable insulating material placed in an outer container, and maintaining the cups in the insulating material in a predetermined vertical or substantially vertical position.

The method may include inserting the cups into holes made for the receiving of cups made from the resiliently deformable insulating material in the outer container and closing a lid of the container having a layer of resiliently deformable insulating material located therein thereby to snugly hold said cups in said resiliently deformable insulating material.

### DESCRIPTION OF EMBODIMENTS OF THE INVENTION

The invention will now be described by way of non-limiting example only with reference to the drawings. In the drawings,

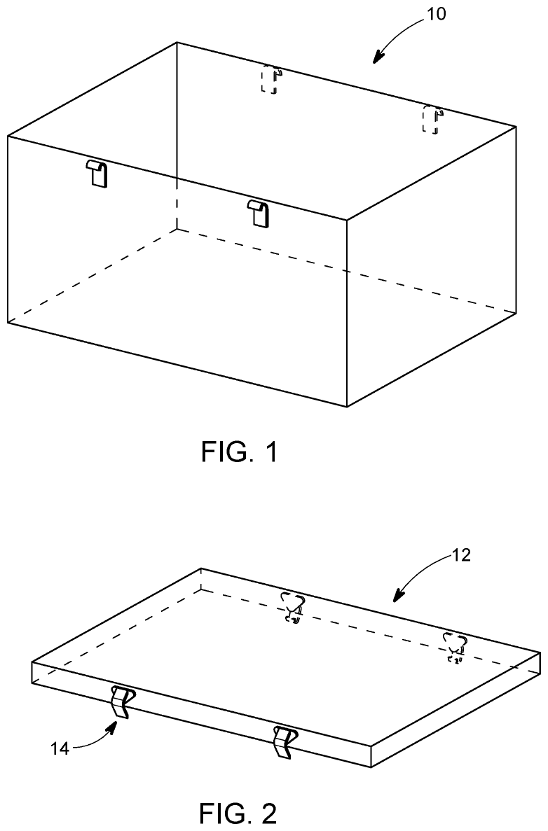

FIG. 1 shows a plastic container box;

FIG. 2 shows a lid for the plastic container, said lid having clips;

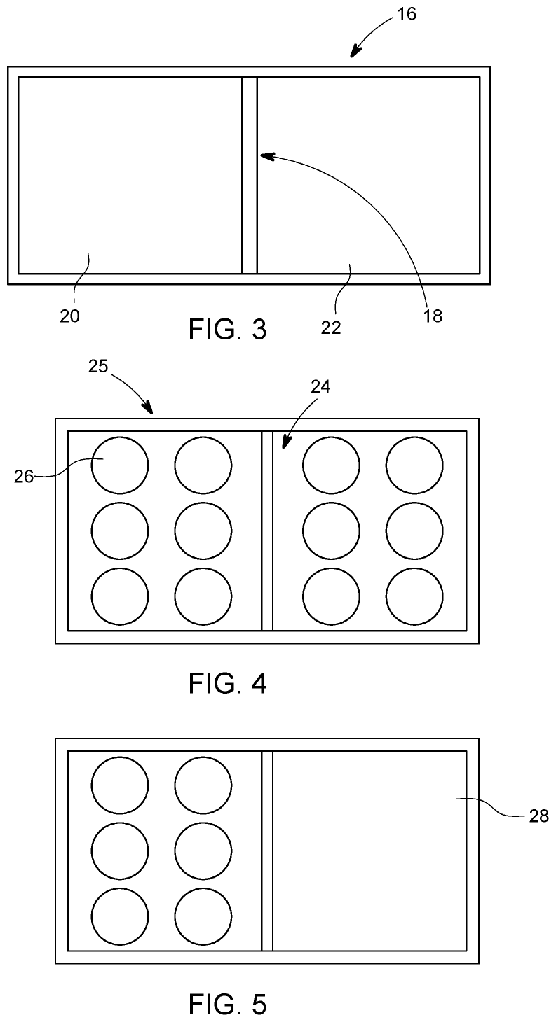

FIG. 3 shows side panels of the container with panel inserts to divide the container;

FIG. 4. shows middle sponge or foam body with cup receiving cavities;

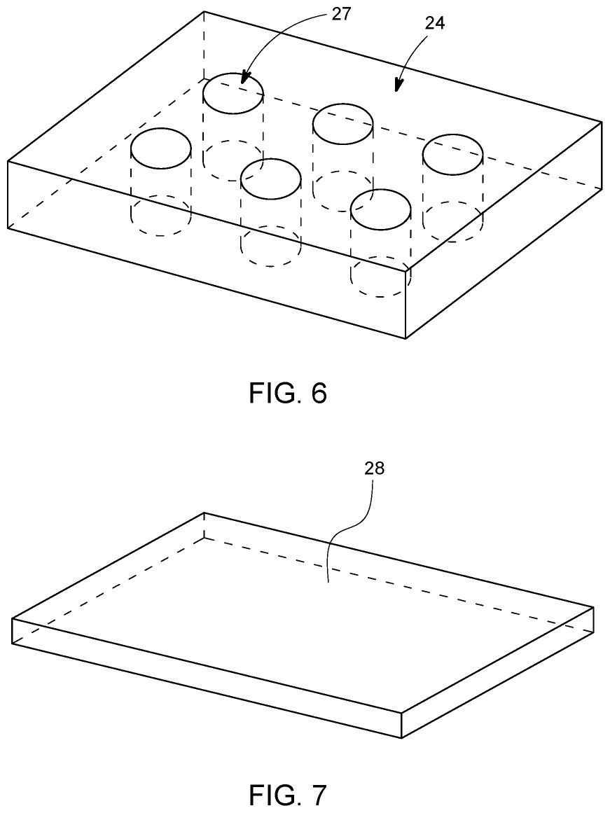

FIG. 5 shows an optionally removable middle sponge or foam layer for transporting other non-beverage food-stuff to only rest onto bottom sponge or foam layer;

FIG. 6 shows the configuration of the middle sponge or foam layer as well as cup receiving cavities;

FIG. 7 shows a bottom sponge of foam layer;

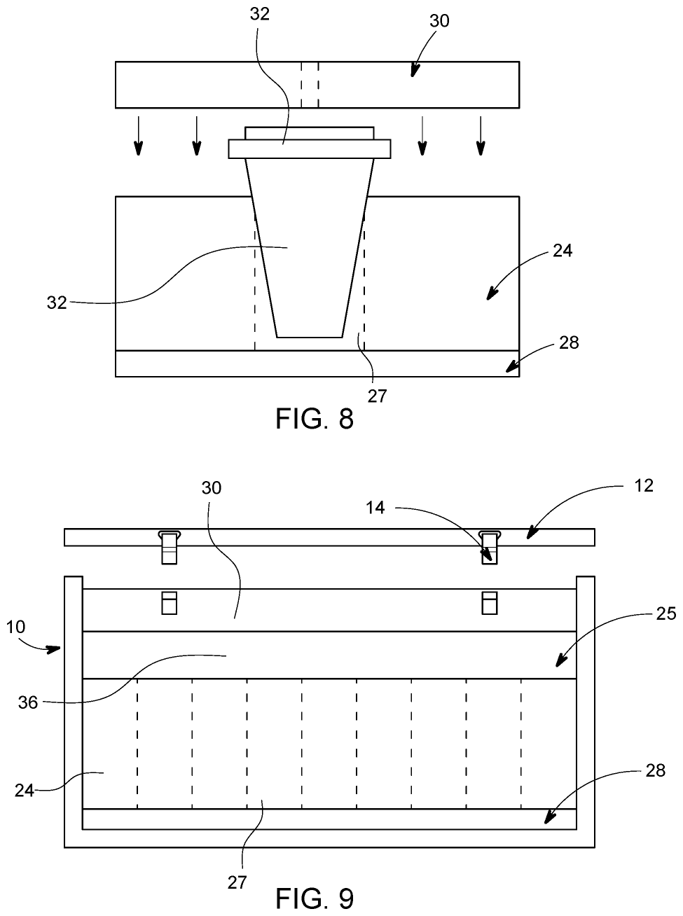

FIG. 8 shows a top sponge or foam layer closing on lids of cups engaged in middle sponge or foam layer;

FIG. 9 shows an insulating holder assembly showing air gap between top sponge or foam layer and middle sponge or foam layer;

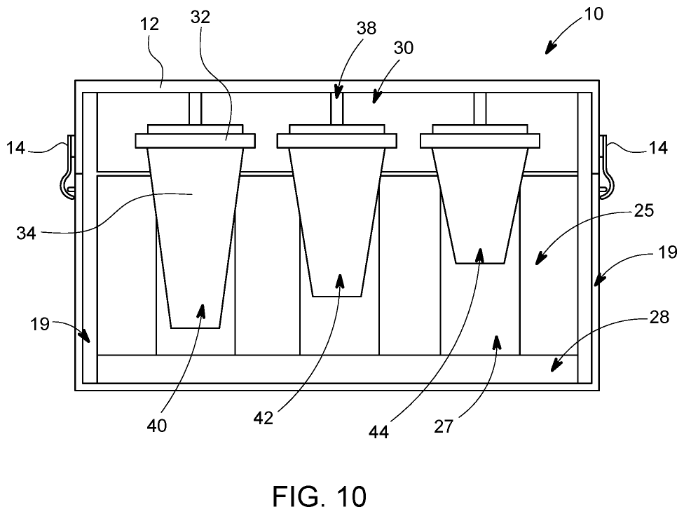

FIG. 10 shows an assembled container with closing lid clipped-in;

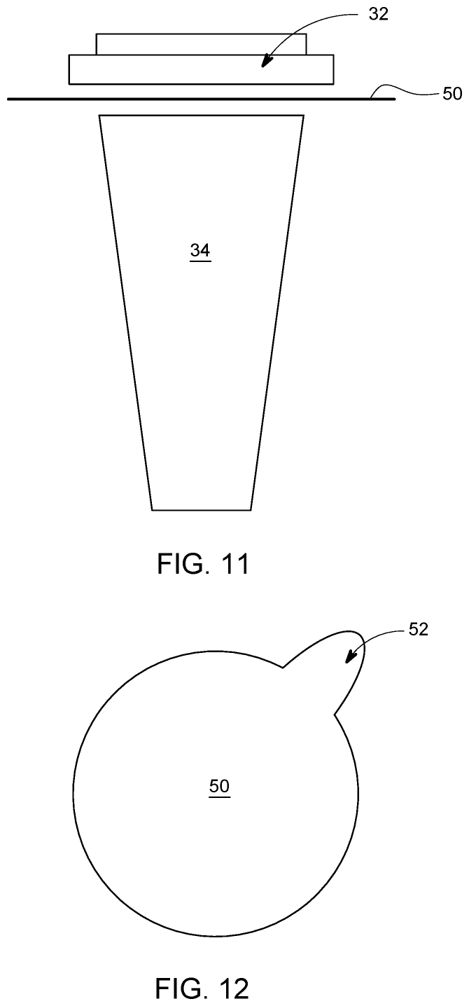

FIG. 11 shows diameters top and bottom of cups as well as wax paper insert;

FIG. 12 shows a wax paper insert folding over top of the cup; and

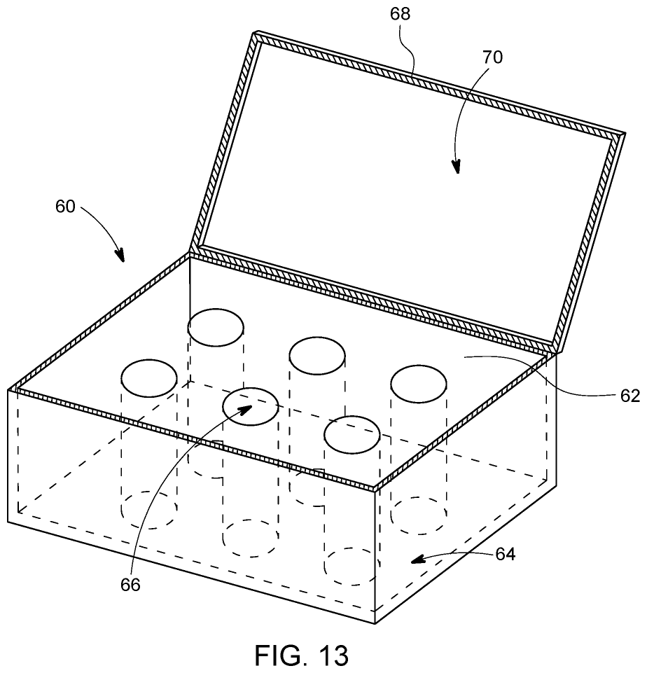

FIG. 13 shows an embodiment of the insulating container having a bottom foam layer, cup receiving cavities in a middle flam layer, a zip to close the container, and a top foam layer.

FIG. 1 shows a plastic container box 10 and FIG. 2 shows a lid 12 for the plastic container 10, said lid having clips 14.

FIG. 3 shows side panels of the container 16 with polystyrene panel inserts 18 to divide the container into compartments 20, 22.

FIG. 4 shows a middle sponge layer 24 of the insulating holder 25 with cup receiving cavities 26 and FIG. 5 shows an optionally removable middle sponge layer removed for transporting other non-beverage food-stuff to only rest onto bottom sponge layer 28.

In FIG. 6, there is shown an embodiment wherein the sponge layer 24 of the insulating holder is 220 mm by 330 mm by 100 mm high and has extending therethrough holes 27 for receiving cups of approximately 65 mm diameter. The insulating holder is made of sponge. FIG. 7 shows the bottom sponge layer 28 of approximately 20 mm in this embodiment.

In FIG. 8 a top sponge layer 30 of approximately 50 mm thickness closes and presses onto lids 32 of cups 34 engaged held in the holes 27 of the middle sponge layer 24 while being spaced from the bottom sponge layer 28.

In FIG. 9, the container 10 with lid 12 and clips 14 includes therein an insulating holder 25 assembly with the top sponge layer 30, and middle sponge layer 24, a bottom sponge 28 and an air gap 36 between the top sponge layer 30 and sponge body 24.

In FIG. 10, the container 10 with lid 12 and clips 14 includes therein an insulating holder 25 assembly with the top sponge layer 30 with a steam release hole 38 in the sponge 30, and middle sponge layer 24, with cup holding holes 27 therethrough and a bottom sponge 28. Cups 34 with lids 32 of different sizes are shown i.e. a 135 mm tall cup 40, a 110 mm medium cup 42 and a 90 mm small cup 44 all having a shoulder diameter of approximately 80 mm of the hole 27 (hole 27 diameter is approximately 65 mm). The top sponge layer 30 presses down onto the lids 32 of the cups 34 ad deforms to hold them firmly. The container 10 has polystyrene inserted side panels 19.

FIGS. 11 and 12 show a cup 34 with a lid 32 wherein a wax paper insert 50 is inserted between the lid 32 and the cup 34 before the lid is clipped on. In this embodiment the wax paper insert is 110 mm diameter at its round portion and has a finger tag 52 extending therefrom. The top of the cup is 85 mm in diameter and the base of the cup is 55 mm in diameter.

FIG. 13 an embodiment of a container 60, having an insulating container 62 having a bottom foam body 64, cup receiving cavities 66, a zip to close the container 68 and a top foam layer 70.

It is an advantage of the invention that various aspects of the invention permit delivery of hot or cold beverages while maintaining their temperature while inhibiting in transit spillage.

1-21. (canceled)

22. An insert cover fora beverage cup, said insert cover being a sheet of food grade material which is larger or equivalent in diameter to the top of the cup on which it is to be used and, in use, is placed or inserted to form a cover insert between the top of the cup and a sealing lid, provided that the cover is not sealed or otherwise secured to the cup prior to placing of the lid onto the cup and is only inserted after a beverage has been dispensed into the cup.

23. The insert cover as claimed in claim 22, which is selected from a wax paper insert, natural fiber/cellulose based insert, a composite sheet or polymer film based insert, a silicon based insert, or metallized film.

24. A method of inhibiting spillage of a beverage from a disposable or re-usable cup when being transported, said method including:
dispensing a beverage into the cup;
placing a cover insert for the beverage between a lip at the top of a cup and a clip on lid for the cup, which cover is made of food grade material, and which is larger or equivalent in diameter to the top of the cup on which it is to be used,
in which method the cover is not sealed or otherwise secured to the cup prior to placing of the lid onto the cup and is only placed in position after the beverage has been dispensed into the cup and is held in place by gravity or the clip on lid.

25. A method of inhibiting spillage of a beverage from a disposable or re-usable cup when being transported as claimed in claim 24, including snugly holding said cups in a resiliently deformable insulating material placed in an outer transport container, and maintaining the cups in the insulating material in a predetermined vertical or substantially vertical position.

26. A method of inhibiting spillage of a beverage from a disposable or re-usable cup when being transported as claimed in claim 24, wherein the method includes inserting the cups into holes made for the receiving of cups made from the resiliently deformable insulating material in the transport container and closing a lid of the transport container having a layer of resiliently deformable insulating material located therein thereby to snugly hold said cups in said resiliently deformable insulating material.

27. An insulating transport container for transportation of beverages in ready to drink on demand beverage containers over short distances where temperature control is needed inside the beverage container when transporting the hot or cold beverages and which includes an insulating holder for cups positioned or placed therein, which insulating holder reduces temperature changes and inhibits spillage during transportation of cups containing a beverage, wherein the holder includes one or more self supporting resiliently deformable insulating material portions with at least one portion having a plurality of cup receiving cavities, which holder is sized and dimensioned to be placed inside the transport container for the transportation of beverages.

28. The insulating transport container for transportation of beverages as claimed in claim 27, wherein the resiliently deformable insulating material is selected from foam and sponge.

29. The insulating transport container for transportation of beverages as claimed in claim 27, wherein the one or more self supporting resiliently deformable insulating material portions are in the form of a bottom layer, a middle layer and a top layer.

30. The insulating transport container for transportation of beverages as claimed in claim 29, wherein the layers are selected from individual layers or two or more layers being secured together.

31. The insulating transport container for transportation of beverages as claimed in claim 27, wherein the plurality of cup-receiving cavities are each spaced apart from the other and extend through the middle layer thereby to permit the cups retained therein to be maintained to be interference free of each other.

32. The insulating transport container for transportation of beverages as claimed in claim 27, wherein the diameter of the cavities is smaller than the largest diameter of the smallest cup of the cups to be received therein thereby to provide a snug-fit for each cup.

33. The insulating transport container for transportation of beverages as claimed in claim 29, which has a base portion, sidewalls, and a displaceable lid with the height between the base portion and the inner surface of the lid being greater than the height of any cup to be transported therein, with the top-end of each cup, once placed in position, protruding from the insulating holder's middle layer irrespective the various heights of each cup.

34. The insulating transport container for transportation of beverages as claimed in claim 29, which has the top sponge layer adjacent an inner surface of the lid thereof so that in use it closes onto the lids off each of the cups, leaving an air gap between the top and middle sponge layers where the lids and the top quarter of the cups will be located.

35. The insulating transport container for transportation of beverages as claimed in claim 29, which includes four polystyrene side panel inserts at or on the sidewalls to enhance insulation inside the transport container when closed.

36. The insulating transport container for transportation of beverages as claimed in claim 34, wherein the bottom sponge layer is placed at or on the base portion of the container to assist with absorbing any minor spillage or condensation that may occur during transportation.

37. The insulating transport container for transportation of beverages as claimed in claim 27 made of flexible canvas material.

38. The insulating transport container for transportation of beverages as claimed in claim 31, wherein an additional polystyrene panel is inserted in a central portion of the transport container to divide the transport container into two smaller “pockets” or halves that improves insulation and can be used for hot and cold beverages simultaneously in the same transport container.

39. The insulating transport container for transportation of beverages as claimed in claim 29, wherein the top sponge layer has steam release holes if, in use, steam needs to be vented or released from a small hole in each of the lids covering the cups.

40. An insulating transport container for transportation of beverages as claimed in claim 27, which includes an insulating holder which reduces temperature changes and inhibits spillage during transportation of cups containing a beverage, wherein the holder includes a self supporting resiliently deformable insulating material portions with a plurality of cup receiving cavities.

41. An insulating transport container for transportation of beverages as claimed in claim 40, wherein the holder includes a self supporting resiliently deformable insulating material portions with a plurality of cup receiving cavities, wherein the top layer stabilizes the lids and the cups.
